(19) United States
(12) Patent Application Publication
(10) Pub. No.: US 2009/0251252 A1
(43) Pub. Date: Oct. 8, 2009

(54) Electromagnetic work holding system

(75) Inventors: Huijun Wang, Peoria, IL (US); Fernando Martinez Diez, Peoria, IL (US); Keith Alan Herman, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/078,675

(22) Filed: Apr. 3, 2008

(51) Int. Cl. H01F 7/20

(52) U.S. Cl. 335/290

(57) ABSTRACT

The present disclosure is directed to a work holding system. The work holding system may include a plurality of electromagnets connected to a support structure and configured to fix a magnetic workpiece to the support structure. Further the work holding system may include a controller configured to selectively adjust an activation state of one or more electromagnets based upon a proximity of work being done on the magnetic workpiece.

### TECHNICAL FIELD

The present disclosure relates generally to a work holding system and, more particularly to an electromagnetic work holding system.

### BACKGROUND

Magnetic work holding systems are commonly used to hold magnetic workpieces during various fabrication processes such as, for example, welding, machining, cutting, and assembly. In general, such work holding systems employ one or more magnets to secure the magnetic workpiece to a surface of the magnetic work holding system. Some magnetic work holding systems employ permanent magnets combined with an actuating mechanism. The actuating mechanism is configured to shift pole pieces relative to the permanent magnets to adjust a magnetic field.

Although permanent magnet work holding systems may be able to hold magnetic workpieces to the surface of the work holding system during fabrication processes, a more substantial magnetic force may be required. For example, even a small movement during a fabrication process may result in damage to an expensive workpiece or to an expensive tool. Further, permanent magnets may not yield a uniform magnetic field and, thus, the magnetic workpiece may not be securely held to the surface of the magnetic work holding system. Additionally, the strength of the magnetic field of permanent magnets may not be adjustable.

One method for securely holding a magnetic workpiece is described in U.S. Pat. No. 6,489,871 (the '871 patent) issued to Barton. The '871 patent describes a selectable electromagnet for holding magnetic workpieces. The electromagnets included within the apparatus described by the '871 patent may be switched between an activated state and a deactivated state. In the activated state, the electromagnets extend a magnetic field into the magnetic workpiece. In the deactivated state, the magnetic field is not extended into the workpiece. Additionally, the magnetic field generated by the apparatus of the '871 patent is adjustable and may be controlled to provide for a consistent magnetic field throughout the work holding system.

Although the magnetic work holding system of the '871 patent provides selectable electromagnets capable of varying the magnetic field strength. The electromagnets may not be individually selectable. All of the electromagnets may be in the activated state or all of the electromagnets may be in the deactivated state. Further, the magnetic field generated by the electromagnets while in the activated state may have adverse effects on fabrication processes. For example, arc welding may experience a condition known as “arc blow” in the presence of electromagnetic fields. Arc blow may cause excessive spatter, incomplete fusion, weld porosity, and an irregular weld.

The work holding system of the present disclosure is directed to overcoming one or more of the shortcomings set forth above and/or other problems in the art.

### SUMMARY

In one aspect, the present disclosure is directed to a work holding system. The work holding system may include a plurality of electromagnets connected to a support structure and configured to fix a magnetic workpiece to the support structure. Further the work holding system may include a controller configured to selectively adjust an activation state of one or more electromagnets based upon a proximity of work being done on the magnetic workpiece.

In another aspect, the present disclosure is directed to a method of controlling a work holding system. The method may include selectively activating a plurality of electromagnets to hold a magnetic workpiece to the work holding system. The method may further include determining a position of a tool acting on the magnetic workpiece and selectively adjusting one or more electromagnets based upon the position of the tool acting on the magnetic workpiece with respect to a position of one or more electromagnets.

### BRIEF DESCRIPTION OF THE DRAWINGS

FIG. 1 is a diagrammatic illustration of an exemplary disclosed fabrication system;

FIG. 2 is a diagrammatic illustration of an exemplary disclosed work holding system for use with the exemplary disclosed fabrication system of FIG. 1; and

FIG. 3 is a flow diagram illustrating an exemplary control method performed the exemplary disclosed fabrication system of FIG. 1.

### DETAILED DESCRIPTION

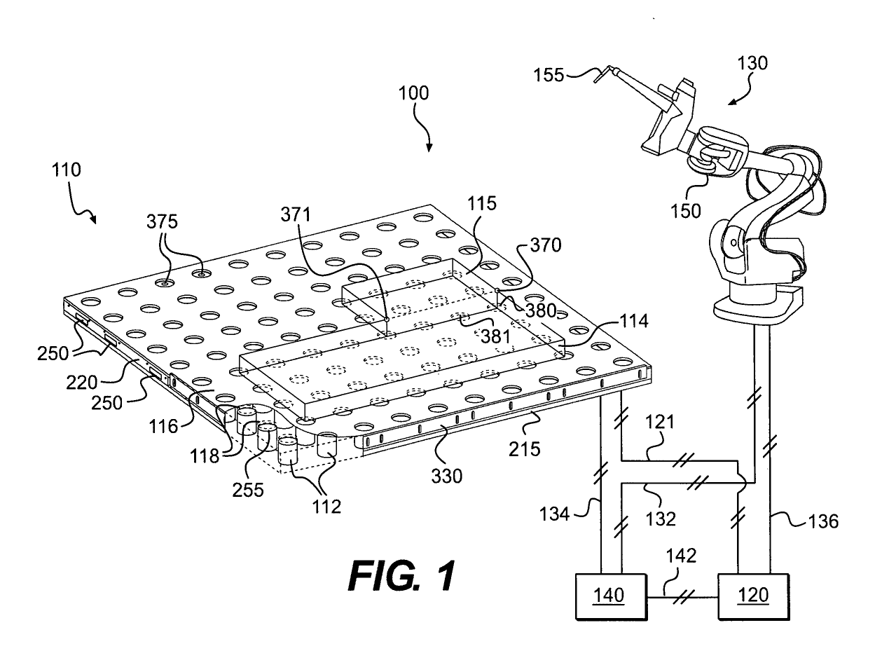

An exemplary embodiment of a fabrication system 100 is shown in FIG. 1. Fabrication system 100 may include various tools to make or change structures, machines, process equipment, and/or other hardware for a wide range of industries. These industries may include, for example, mining, construction, farming, power generation, transportation, or any other industry known in the art. It is contemplated that fabrication system 100 may be used in any environment to hold any magnetic workpiece. For example, fabrication system 100 may be employed to fabricate a hydraulic system for a wheel loader used in the construction industry. As shown in the embodiment of FIG. 1, fabrication system 100 may include a work holding system 110, a fabrication apparatus 130, a power source 120, and a controller 140.

As shown in FIG. 1, work holding system 110 may be an electromagnetic work holding system and may be configured to secure a first magnetic workpiece 114 and a second magnetic workpiece 115 during various fabrication processes. For example, magnetic workpiece 114 and magnetic workpiece 115 may be secured by work holding system 110 for an arc welding process. Work holding system 110 may include a surface member 116 and a plurality of electromagnets 112 to secure magnetic workpieces 114, 115 to surface member 116. Each electromagnet 112 may be associated with a cutout 118 and may or may not be disposed, at least partially, within surface member 116. It is contemplated that each electromagnet 112 may or may not be flush with surface member 116. If each electromagnet 112 is not flush with surface member 116, a gap 255 may exist between the top of each electromagnet 112 and surface member 116. Gap 255 may provide a pocket of air to insulate each electromagnet 112 from any heat generated by the fabrication process.

Each electromagnet 112 may be a conventional electromagnet as known in the art and may be connected to a base plate 215. Base plate 215 may be constructed of an electrically conducting material, such as, for example, steel. Base plate 215 and surface member 116 may be included to provide a structural support to connect each electromagnet 112 to work holding system 110. For example, each electromagnet 112 may be bolted, riveted, welded, or fastened to base plate 215 using any other method apparent to one skilled in the art.

Each electromagnet 112 may have an activated state and a deactivated state and these states may be selectively adjusted by controller 140. In the activated state, an electrical energy may flow from power source 120 to electromagnets 112 and may generate a magnetic field around each electromagnet 112. In the deactivated state, the magnetic field may be reduced from the activated state or may be eliminated by slowing or stopping the flow of electrical energy to each electromagnet 112 from power source 120. It is contemplated that electrical energy supplied to each electromagnet 112 may be reversed for a short period of time prior to reducing or stopping the flow of electrical energy. This reversal of the flow of electrical energy may help to eliminate a residual magnetic field. It is further contemplated that the activation state of each electromagnet 112 may be selectively adjusted and that only electromagnets in the vicinity of magnetic workpieces 114, 115 may be commanded into an activated state by controller 140.

The magnetic field generated by each electromagnet 112 in an activated state may be strong enough to cause arc blow during the arc welding process. As such, each electromagnet 112 within a predefined proximity to the fabrication process may be selectively adjusted into a deactivated state. Alternatively, electromagnets outside of the predetermined proximity to the fabrication process may be commanded into an activated state to secure magnetic workpieces 114, 115 to surface member 116. It is contemplated that a variety of methodologies may be employed to activate and deactivate each electromagnet 112. For example, controller 140 may employ a rectangular coordinate system and track an arc welder performed automated fabrication process with respect to known locations of each electromagnet 112. Additionally or alternatively, sensors may be associated with the plurality of electromagnets 112 to sense a change in various parameters. Controlling the activation state of each electromagnet 112 will be discussed with respect to controller 140 below.

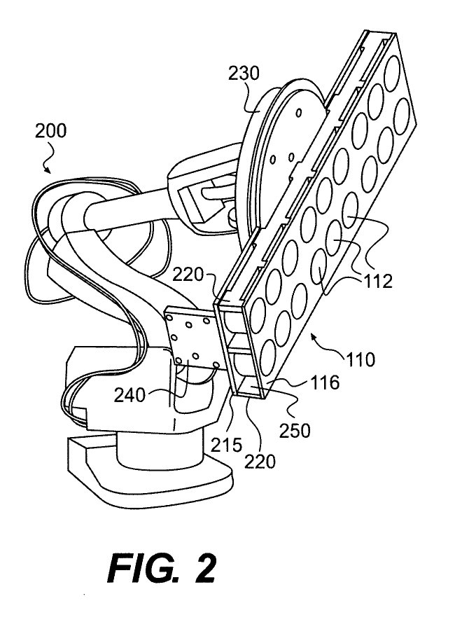

Work holding system 110 may also include a web plate 220, openings 250, a grounding plate 240 (shown in FIG. 2), and a hard stop 330. Web plate 220 may be constructed of an electrically conducting material such as, for example, steel. Web plate 220 may be disposed between surface member 116 and base plate 215 to provide structural rigidity to work holding system 110.

Web plate 220 may include various openings 250. Openings 250 may allow air to flow between surface member 116 and base plate 215 thereby allowing work holding system 110 to be cooled by convection. For example, gap 255 may facilitate convection by allowing a flow of air to pass between surface member 116 and base plate 215. It is contemplated that a cooling device may be added to work holding system 110 to facilitate cooling by forced convection. For example, the cooling device may facilitate cooling by forced convection using compressed air or may employ a fan to draw air flow through openings 250.

Grounding plate 240 may be connected to base plate 215 or any other conducting portion of work holding system 110 to direct an electrical current to power source 120 throughout work holding system 110. For example, the electrical current may be conducted by base plate 215, web plate 220, surface member 116, and magnetic workpiece 114 from an electrode tip 155. It is contemplated that grounding plate 240 may be omitted and arc welding process may be directed through a second electrode (not shown) attached to fabrication apparatus 130.

Hard stop 330 may be connected to work holding system 110 via base plate 215, web plate 220, and/or surface member 116. Hard stop 330 may protrude above surface member 116 and be used to restrict movement of magnetic workpiece 114. Further, hard stop 330 may also be use to align magnetic workpiece 114. For example, magnetic workpiece 114 may be positioned against hard stop 330 to align magnetic workpiece 114 with respect to surface member 116 for the fabrication process.

Fabrication apparatus 130 may include hardware associated with a welding, a machining, a cutting, and/or an assembly process. For example, fabrication apparatus 130 may include hardware associated with arc welding, plasma cutting, or any other hardware known to one skilled in the art to be affected by electromagnetic fields. In the embodiment shown in FIG. 1, fabrication apparatus 130 may be an arc welding machine and may be operably attached to a robotic effector arm 150 to perform an automated arc welding process.

Robotic effector arm 150 may be capable of moving and manipulating electrode tip 155 of fabrication apparatus 130 through space. Robotic effector arm 150 may include various hydraulic and electrical components configured to adjust a position of electrode tip 155. Further, movement of robotic effector arm 150 may be commanded by controller 140. Electrode tip 155 may be used to pass a flow of electrical energy through magnetic workpiece 114 to shape, join, cut, or otherwise manipulate magnetic workpiece 114. It is contemplated that electrode tip 155 may receive the flow of electrical energy from power source 120 through an electrical line 136. Further, it is contemplated that fabrication apparatus 130 may include a consumable or non consumable electrode. One skilled in the art will recognize that robotic effector arm 150 and electrode tip 155 may embody various configurations and may include various additional components which may be used to move electrode tip 155 through space. It is contemplated that fabrication apparatus 130 may include any conventional apparatus configured to manipulate magnetic workpieces 114, 115.

In addition to providing electrical energy to fabrication apparatus 130, power source 120 may also provide a source of electrical energy to work holding system 110 and controller 140. It is contemplated that power source 120 may provide various sources of electrical energy and that those sources may be either alternating current or direct current. It is further contemplated that multiple power sources may be used and that work holding system 110, fabrication apparatus 130, and controller 140 may all have individual power supplies. Power source 120 may be connected to work holding system 110 via a work holding system electrical supply line 121, to fabrication apparatus 130 via a welding apparatus electrical supply line 136, and to controller 140 via a controller electrical supply line 142.

Controller 140 may embody a single microprocessor, or multiple microprocessors for controlling and operating components of fabrication system 100. Numerous commercially available microprocessors may be configured to perform the functions of controller 140. It should be appreciated that controller 140 could readily embody a general microprocessor capable of controlling numerous operating functions. Controller 140 may include a memory, a secondary storage device, a processor, and any other components for running an application. Various other circuits may be associated with controller 140 such as a power source circuit, a signal conditioning circuit, and other types of circuits. Controller 140 may communicate with work holding system 110 via a work holding system communication line 134 and to fabrication apparatus 130 via a fabrication apparatus communication line 132.

One or more maps relating various system parameters may be stored in the memory of controller 140. Each of these maps may include a collection of data in the form of tables, graphs, equations and/or another suitable form. The maps may be automatically or manually selected and/or modified by controller 140 to affect movement of fabrication apparatus 130 or activation state of each electromagnet 112. For example, one such map, that is, a control map, may include a predetermined adjustment sequence. That is, the controller may include a collection of commands associated with the movement of electrode tip 155. That is, the control map may be stored within the memory of controller 140 and may include commands for a specific welding process. The specific welding process may contain various collections of information such as the size and location of the magnetic workpieces 114, 115 with respect to the work holding deice 110. In an addition, controller 140 may also include a positional map. The positional map may include the relative positions of each electromagnet 112, that is, the positional maps may include the position of each electromagnet 112 disposed within the work holding system 110.

Controller 140 may be configured to selectively adjust the activation state of each electromagnet 112. For example, after magnetic workpieces 114, 115 have been positioned with respect to work holding system 110, controller 140 may activate one or more electromagnets 112. Upon securing magnetic workpiece 114, 115 to the work holding system 110, controller 140 may command operation of the fabrication process. In this example, controller 140 may command operation of an arc welding process or a material removal process from a first position 370 to a second position 371. That is, controller 140 may command electrode tip 155 to weld magnetic workpieces 114, 115 from first position 370 to second position 371 while welding magnetic workpieces 114, 115 together.

By using a coordinate system and comparing the commands within the control map against the positional map, controller 140 may be able to determine a movement of electrode tip 155 to a position within the predetermined proximity of a first electromagnet 380. Upon making this determination, controller 140 may command first electromagnet 380 into the deactivated state. While in the deactivated state, first electromagnet 380 may not generate a strong magnetic field and, thus may not adversely affect the arc welding process. As the electrode tip 155 moves out of the predetermined proximity of the first electromagnet 380 and into the predetermined proximity of a second electromagnet 381, first electromagnet 380 may be commanded into the activated state and second electromagnet 381 may be commanded into the deactivated state.

In addition to and/or alternatively, work holding system 110 may include a sensor associated with the plurality of electromagnets 112. These sensors may be configured to sense a change in parameters indicative of tool position, such as, for example, a change in temperature. That is, a temperature sensor 375 may be associated each electromagnet 112 and may generate a signal based on a change in temperature associated with the arc welding process and may be disposed within the predetermined proximity of each electromagnet 112. Because the arc welding process generates heat as it welds, temperature sensor 375 may detect a rapid increase in temperature as electrode tip 155 enters the predetermined proximity. It is contemplated there may be fewer temperature sensors 375 than electromagnets 112, for example, one temperature sensor 375 may be associated with more than one electromagnet 112. It is further contemplated that controller 140 may adjust the activation state of multiple electromagnets 112 based on a signal from one temperature sensor or visa versa.

The signals generated by temperature sensor 375 may be directed toward controller 140. Controller 140 may determine, based upon the signal, that an arc welding process has entered the predetermined proximity. Upon determining that the arc welding process has entered the predetermined proximity, controller 140 may selectively deactivate each electromagnet 112 associated with temperature sensor 375. Likewise, when electrode tip 155 moves away from temperature sensor 375, the temperature may drop and temperature sensor 375 may then generate a signal indicative of a reduced temperature. Upon receiving the signal indicative of a reduced temperature, controller 140 may command each electromagnet 112 associated with temperature sensor 375 into the activated state. It is contemplated that controller 140 may use maps in conjunction with an automated fabrication process and may use temperature sensor 375 in conjunction with either an automated fabrication process or a manual fabrication process. It is further contemplated that work holding system 110 may be fixed, for example, to a table, work bench, or other relatively stable structure, or may be fixed to a moveable structure such as, for example a robotic arm.

FIG. 2 illustrates work holding system 110 attached to a robotic effector arm 200. Robotic effector arm 200 may be configured to move work holding system 110 and manipulate the magnetic workpiece 114 (FIG. 1) through space. It is contemplated that robotic effector arm 200 may move magnetic workpiece 114 with respect to electrode tip 155 (FIG. 1) or that both effector arm 200 and electrode tip may move with respect to a fixed point of reference.

As previously described above with respect to fabrication apparatus 130, robotic effector arm 200 may include various hydraulic and electrical components and may be commanded by controller 140 to move work holding system 110. In addition to the components shown in to FIG. 1, work holding system 110 may also include various other components. Particularly, work holding system 110 may include a liquid cooling device 230.

Liquid cooling device 230 may be disposed between an electrical insulator (not shown) and work holding system 110. The electrical insulator may be constructed of a thermal plastic and may be sensitive to the high temperatures created by the arc welding process. Liquid cooling device 230 may be configured to cool the electrical insulator an may include various components to remove heat. For example, liquid cooling device 230 may circulate water through a vane (not shown) to remove heat from work holding system 110. It is contemplated that various devices may be configured to cool work holding system 110 and and/or robotic effector arm 200, or that liquid cooling device 230 may be omitted.

It is contemplated that additionally or alternatively, fabrication apparatus 130 may embody various tools for various other fabrication processes. These fabrication processes may include welding, machining, cutting, assembly, or any other fabrication process known in the art. For example, electrode tip 155 may be replaced with a cutting bit for a machining process. In this example, electromagnets 112 may switch from the activated state to the deactivated state as disclosed above so that the machine process may not be adversely affected by magnetic fields. Specifically, electromagnets 112 may be switched to the deactivated state so that magnetic workpieces 114, 115 may not collect debris during the machining process. Further, cooling device 230 may be included and may remove heat associated with the friction caused during the machining process.

### INDUSTRIAL APPLICABILITY

Fabrication system 100 may be used to make or change structures, machines, equipment, and/or other hardware or workpieces for a wide range of industries. These industries may include, for example, mining, construction, farming, power generation, transportation, or any other industry known in the art. It is contemplated that fabrication system 100 may be used in any environment to hold any magnetic element. For example, fabrication system 100 may be employed to fabricate a hydraulic system for a wheel loader used in the construction industry.

Further, the disclosed method and apparatus may be used in any environment to hold any magnetic workpiece. For example, the disclosed method and apparatus may be used with processes that be adversely affected by magnetic fields. As disclosed above, work holding system 110 may employ one or more electromagnets 112 that are configured to be individually activated by controller 140 between at least two activation states. Each electromagnet 112 commanded into the activated state may generate a magnetic field to hold magnetic workpiece 114 to surface member 116. Conversely, when commanded into the deactivated state, each electromagnet 112 may not generate the electromagnetic field and, thus, may not interfere with the arc welding process or another fabrication process. This apparatus and method may provide for improved fabrication processes, the operation of which will now be explained with respect to method 400.

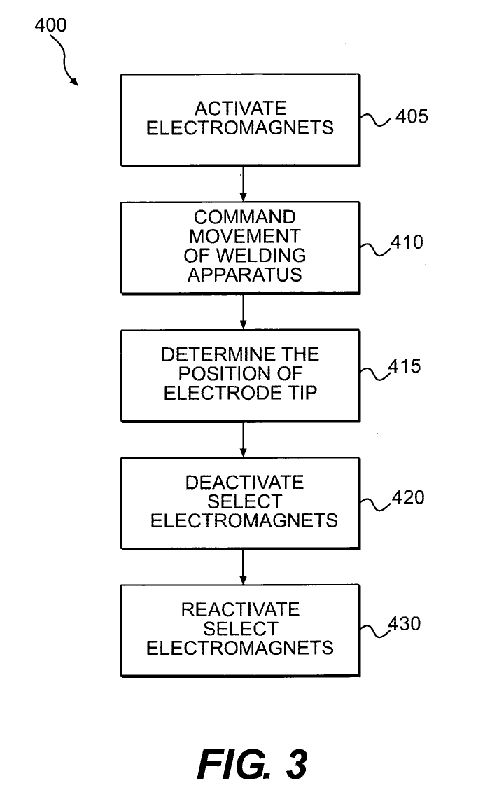

Referring now to FIG. 3, beginning with each electromagnet 112 in the deactivated state, magnetic workpiece 114 may be positioned onto work holding system 110. For this example, work holding system 110 may embody a workbench. In this embodiment, magnetic workpiece 114 may be positioned onto the workbench against hard stop 330. Once the magnetic workpiece 114 is in place, each electromagnet 112 may be commanded into the activated state by controller 140 (Step 405). After electromagnets 112 have been commanded into the activated state, a fabrication process may begin, for this example, the fabrication process may be arc welding. It is contemplated that only electromagnets 112 within a proximity of the magnetic workpiece 114, 115 may be activated. Further, electromagnets 112 that are not positioned within the proximity of the magnetic workpieces 114, 115 may remain in a deactivated state.

As the arc welding process begins, controller 140 may command movement of electrode tip 155 with respect to the workbench and magnetic workpiece 114. As electrode tip 155 comes into the proximity of each activated electromagnet 112, each electromagnet 112 may be commanded into a deactivated state. For example, referring to FIG. 3, as electrode tip 155 comes into the proximity of first electromagnet 380, first electromagnet 380 may be commanded into the deactivated state until electrode tip 155 leaves the proximity of first electromagnet 380.

Controller 140 may be programmed to weld various magnetic workpieces secured to work holding system 110 by one or more electromagnets 112. Welding commands may be read from one or more maps stored within the memory of controller 140. Controller 140 may command movement of fabrication apparatus 130 (step 410) from first position 370 to second position 371 (see FIG. 1). To control the movement of fabrication apparatus 130, a coordinate system may be used. In addition to moving electrode tip 155, the coordinate system may also be used by controller 140 to determine the position of electrode tip 155 with respect to each electromagnet 112 (step 415). Particularly, if controller 140 determines that electrode tip 155 is within the proximity of one or more electromagnets 112, controller 140 may command each electromagnet 112 to deactivate. For example, as electrode tip 155 moves from first position 370 to second position 371 it may come into the proximity of first electromagnet 380 and second electromagnet 381.

When controller 140 determines that electrode tip 155 is within the proximity of first electromagnet 380 and/or second electromagnet 381, controller 140 may selectively switch first and/or second electromagnets 380, 381 to the deactivated state (step 420). While in the deactivated state, first and/or second electromagnets 380, 381 may not generate the magnetic field and, therefore, may not adversely affect the welding process. After controller 140 has commanded electrode tip 155 to move out of the proximity of first and/or second electromagnet 380, 381, first and/or second electromagnet 380, 381 may be reactivated (step 430). That is, first and/or second electromagnets 380, 381 may be commanded back into the activated state. It is contemplated that controller 140 may selectively activate and deactivate any number of electromagnets 112 that may be affected by electrode tip 155. Such deactivating may occur consecutively as electrode tip 155 moves across the magnetic workpiece 114, 115. Further, a plurality of electromagnets 112 or all of the potentially affected electromagnets 112 may be deactivated as electrode tip 155 does work on the magnetic workpieces 114, 115. In each case, controller 140 will leave enough electromagnets activated so that the magnetic workpieces 114, 115 remains adequately secured to work holding system 110. It is further contemplated that work holding system 1 10 may be combined with the robotic effector arm 200 as shown in FIG. 2. Robotic effector arm 200 may be commanded by controller 140 to move work holding system 110 and an attached magnetic workpiece with respect to another work holding system 110 or with respect to an electrode tip 155.

As described herein, each electromagnet 112 may be selectively activated and selectively deactivated by controller 140. It is contemplated that changing the activation state of electromagnets 112 may include reducing the magnetic field strength, reversing the magnetic field polarity or eliminating the magnetic field completely. Since controller 140 may selectively adjust the activation state of each electromagnet 112, adverse affects caused by the magnetic fields generated by each electromagnet 112 on fabrication processes may be avoided. For example, the disclosed method and apparatus may reduce or eliminate arc blow during arc welding processes. This reduction or elimination of arc blow may reduce excessive spatter, incomplete fusion, and weld porosity.

It will be apparent to those skilled in the art that various modifications and variations can be made to the disclosed work holding system without departing from the scope of the disclosure. Other modifications will be apparent to those skilled in the art from consideration of the specification and practice of the work holding system disclosed herein. It is intended that the specification and examples be considered as exemplary only, with a true scope of the invention being indicated by the following claims and their equivalents.

What is claimed is:

1. A work holding system, comprising:
a plurality of electromagnets connected to a support structure and configured to fix a magnetic workpiece to the support structure; and
a controller configured to selectively adjust an activation state of one or more electromagnets based upon a proximity of work being done on the magnetic workpiece.

2. The work holding system of claim 1, wherein the selective adjustment of the activation state of the one or more electromagnets includes reducing a flow of electrical energy to the one or more electromagnets.

3. The work holding system of claim 1, wherein the selective adjustment of the activation state of the one or more electromagnets includes eliminating a flow of electrical energy to the one or more electromagnets.

4. The work holding system of claim 1, where in the selective adjustment of the activation state of the one or more electromagnets includes reducing a flow of the electrical energy to the one or more electromagnets so that an electromagnetic field does not affect the work being done, and thereafter includes increasing a flow of electrical energy to the one or more electromagnets.

5. The work holding system of claim 1, wherein the selective adjustment of the activation state of the one or more electromagnets includes using a predetermined adjustment sequence stored within a memory of the controller.

6. The work holding system of claim i, wherein the selective adjustment of the activation state of the one or more electromagnets is based on a sensed condition.

7. The work holding system of claim 6, wherein the sensed condition is associated with the work being done on the magnetic workpiece.

8. The work holding system of claim 7, wherein the sensed condition is a change in temperature sensed by a temperature sensor associated with the plurality of electromagnets as work is being done on the magnetic workpiece.

9. The work holding system of claim 1, wherein the controller is configured to command a tool that is doing the work on the magnetic workpiece.

10. The work holding system of claim 9, wherein the tool includes an arc welding machine.

11. A method of controlling a work holding system, comprising:
selectively activating a plurality of electromagnets to hold a magnetic workpiece to the work holding system; and
selectively adjusting one or more electromagnets based upon a position of the tool acting on the magnetic workpiece with respect to a position of the one or more electromagnets.

12. The method of claim 11, wherein the selective activation of the plurality of electromagnets to hold the magnetic workpiece includes activating less than all of the plurality of electromagnets to hold the magnetic workpiece.

13. The method of claim 11, further including sensing a parameter indicative of the position of the tool.

14. The method of claim 13, wherein the parameter includes a temperature associated with the magnetic workpiece as work is being done on the magnetic workpiece.

15. The method of claim 11, wherein the selective adjustment of the activation state of the one or more electromagnets includes a predetermined adjustment sequence stored in a controller of the work holding system.

16. The method of claim 11, wherein the selective adjustment of the activation state of the one or more electromagnets includes reducing a flow of electrical energy to the one or more electromagnets.

17. A system for use with a magnetic workpiece, comprising:
a fabrication apparatus;
a work holding system;
a plurality of electromagnets disposed within the work holding system and configured to connect the magnetic workpiece with the work holding system when activated; and
a controller configured to selectively adjust one or more electromagnets within the plurality of electromagnets based upon a position of the fabrication apparatus.

18. The fabrication system of claim 17, wherein the selective adjustment of the one or more electromagnets includes using a predetermined adjustment sequence stored within a memory of the controller.

19. The fabrication system of claim 17, wherein the selective adjustment of the one or more electromagnets is based on a sensed change in temperature associated with the magnetic workpiece as work is being done on the magnetic workpiece.

20. The fabrication system of claim 17, wherein the selective adjustment of the one or more electromagnets is based on position commands sent to a robotic effector arm of the work holding system.
